(19) United States
(12) Patent Application Publication
(10) Pub. No.: US 2017/0264885 A1
(43) Pub. Date: Sep. 14, 2017

(54) FIELD CALIBRATION OF THREE-DIMENSIONAL NON-CONTACT SCANNING SYSTEM

(71) Applicant: CyberOptics Corporation, Golden Valley (MN)

(72) Inventors: Carl E. Haugan, St. Paul, MN (US); Gregory G. Hetzler, Minneapolis, MN (US); David W. Duquette, Minneapolis, MN (US); Jean-Louis Leon Dethier, Bellevue, WA (US); Eric P. Rudd, Hopkins, MN (US)

(73) Assignee: CyberOptics Corporation

(21) Appl. No.: 15/455,635

(22) Filed: Mar. 10, 2017

Related U.S. Application Data
(60) Provisional application No. 62/307,053, filed on Mar. 11, 2016.

(51) Int. Cl. H04N 13/02; F16M 11/20; H04N 17/00; G06T 3/00; G01B 11/25; G06T 7/80

(52) U.S. Cl. CPC H04N 13/0246; G01B 11/2504; G06T 7/85; H04N 17/002; H04N 13/0221; H04N 13/0239; G06T 3/0006; F16M 11/2014; H04N 13/0253

(57) ABSTRACT

A three-dimensional non-contact scanning system is provided. The system includes a stage and at least one scanner configured to scan an object on the stage. A motion control system is configured to generate relative motion between the at least one scanner and the stage. A controller is coupled to the at least one scanner and the motion control system. The controller is configured to perform a field calibration where an artifact having features with known positional relationships is scanned by the at least one scanner in a plurality of different orientations to generate sensed measurement data corresponding to the features. Deviations between the sensed measurement data and the known positional relationships are determined. Based on the determined deviations, a coordinate transform is calculated for each of the at least one scanner where the coordinate transform reduces the determined deviations.

The present application is based on the benefit of priority of the following U.S. provisional patent application with Ser. No. 62/307,053, filed Mar. 11, 2016, the contents of which is hereby incorporated by reference in its entirety.

### BACKGROUND

The ability to replicate the exterior surface of an article, accurately in three-dimensional space, is becoming increasingly useful in a wide variety of fields. Industrial and commercial applications include reverse engineering, inspection of parts and quality control, and for providing digital data suitable for further processing in applications such as computer aided design and automated manufacturing. Educational and cultural applications include the reproduction of three-dimensional works of art, museum artifacts and historical objects, facilitating a detailed study of valuable and often fragile objects, without the need to physically handle the object. Medical applications for full and partial scanning of the human body continue to expand, as well as commercial applications providing 3D representations of products in high detail resolution to internet retail catalogs.

In general, three-dimensional non-contact scanning involves projecting radiant energy, for example laser light or projected white light structured in patterns, onto the exterior surface of an object, and then using a CCD array, CMOS array, or other suitable sensing device to detect radiant energy reflected by the exterior surface. The energy source and energy detector typically are fixed relative to each other and spaced apart by a known distance to facilitate locating the point of reflection by triangulation. In one approach known as laser line scanning, a planar sheet of laser energy is projected onto the object's exterior surface as a line. The object or the scanner can be moved to sweep the line relative to the surface to project the energy over a defined surface area. In another approach known as white light projection or referred to more broadly as structured light, a light pattern (typically patterned white light stripes) is projected onto the object to define a surface area without requiring relative movement of the object and scanner.

Three-dimensional non-contact scanning systems obtain measurements of objects, such as manufactured components at the micron scale. One example of such a three-dimensional non-contact scanning system is sold under the trade designation CyberGage® 360 by LaserDesign Inc. a business unit of CyberOptics Corp. of Golden Valley, Minn. It is desirable for these and other scanning systems to provide measurement stability. However, it is currently difficult to create a three-dimensional, non-contact scanning system that consistently generates accurate measurements while coping with frequent imaging use, aging components, and the many challenges that arise from imaging at such fine granularity. Scanners, and components thereof, such as cameras and projectors often experience mechanical drift with respect to their factory settings. Accuracy can be significantly impacted by the effects of temperature and age on both the cameras and projectors. For example, temperature can affect magnification of the camera which may negatively impact the geometrical accuracy of measurements. These and other sensor opto-mechanical drifts ultimately permeate through the scanning system and impact imaging performance. Further, the effects of mechanical drifts are exacerbated in systems that use multiple sensors.

### SUMMARY

A three-dimensional non-contact scanning system is provided. The system includes a stage and at least one scanner configured to scan an object on the stage. A motion control system is configured to generate relative motion between the at least one scanner and the stage. A controller is coupled to the at least one scanner and the motion control system. The controller is configured to perform a field calibration where an artifact having features with known positional relationships is scanned by the at least one scanner in a plurality of different orientations to generate sensed measurement data corresponding to the features. Deviations between the sensed measurement data and the known positional relationships are determined. Based on the determined deviations, a coordinate transform is calculated for each of the at least one scanner where the coordinate transform reduces the determined deviations.

### BRIEF DESCRIPTION OF THE DRAWINGS

FIG. 1A illustratively shows a simplified block diagram of a three-dimensional non-contact scanning system with which embodiments of the present invention are particularly useful.

FIG. 1B illustratively shows a diagrammatic view of a rotary stage with calibration artifacts for improved calibration features, in accordance with an embodiment of the present invention.

FIGS. 1C-1F illustratively show how errors in calibration may be observed.

FIG. 2A illustratively shows a diagrammatic view of an improved calibration artifact for a scanning system, in accordance with an embodiment of the present invention.

FIG. 2B shows a ball plate calibration artifact placed on rotary stage for calibrating a three-dimensional non-contact scanning system in accordance with an embodiment of the present invention.

FIG. 3 illustratively shows a block diagram of a method of calibrating a scanning system, in accordance with an embodiment of the present invention.

### DETAILED DESCRIPTION OF ILLUSTRATIVE EMBODIMENTS

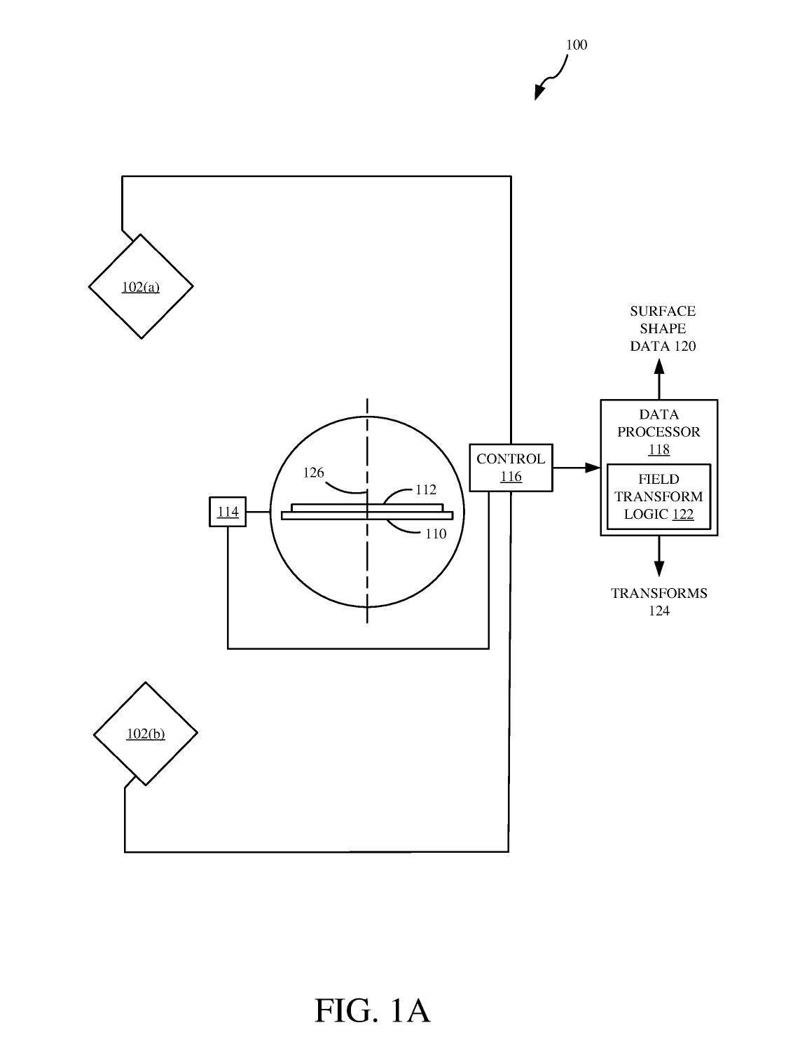

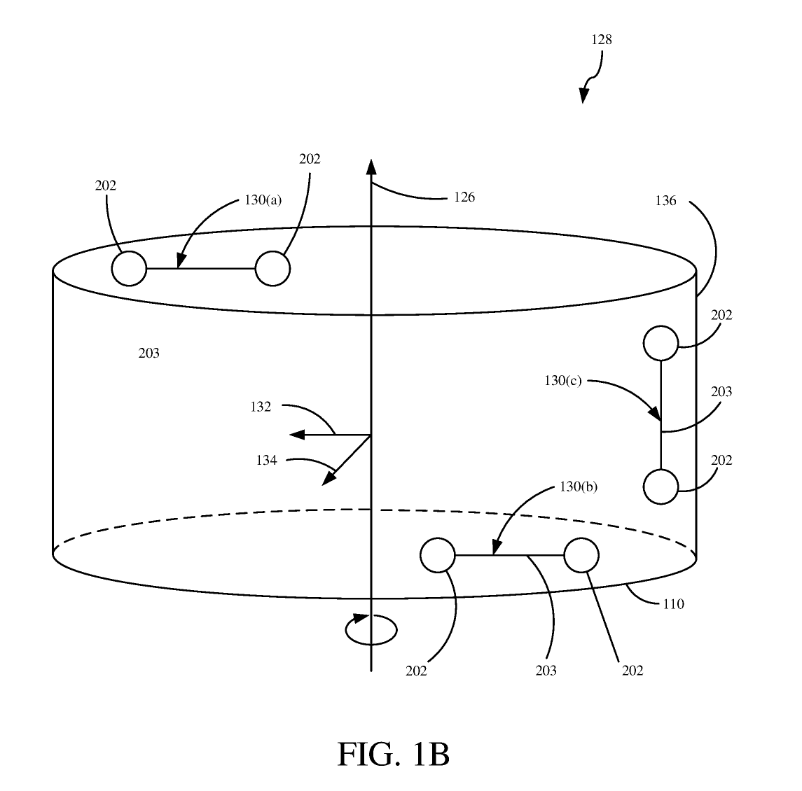

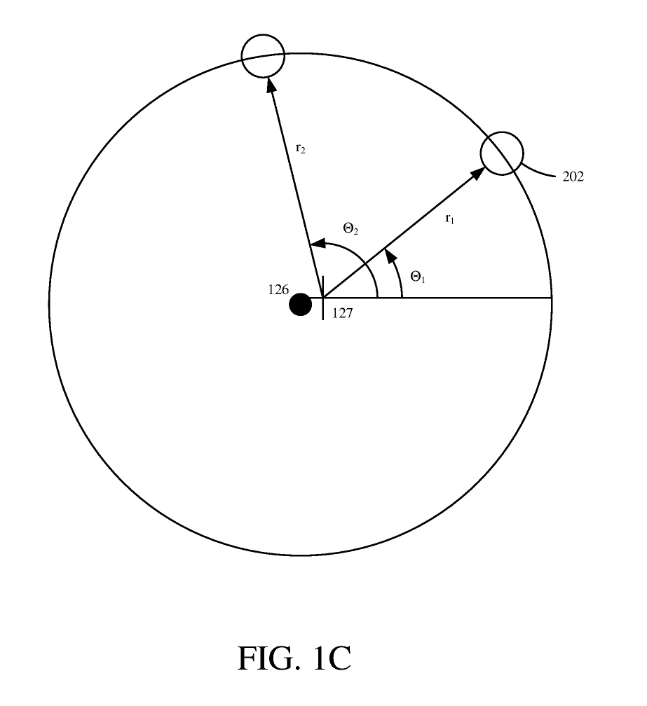

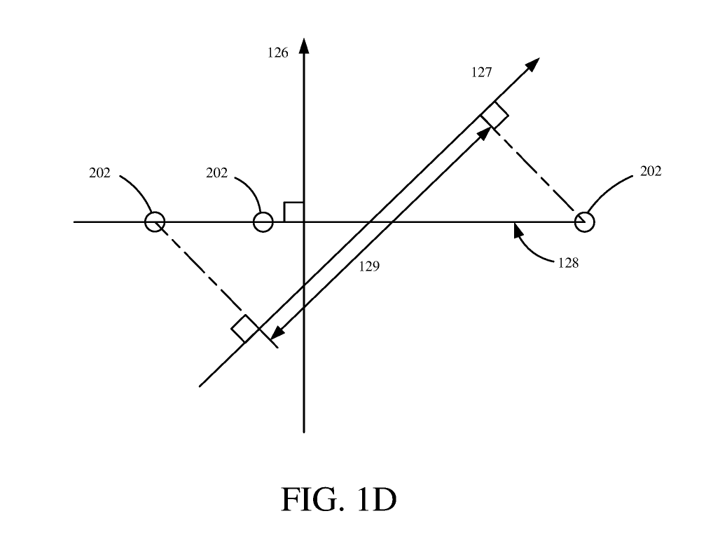

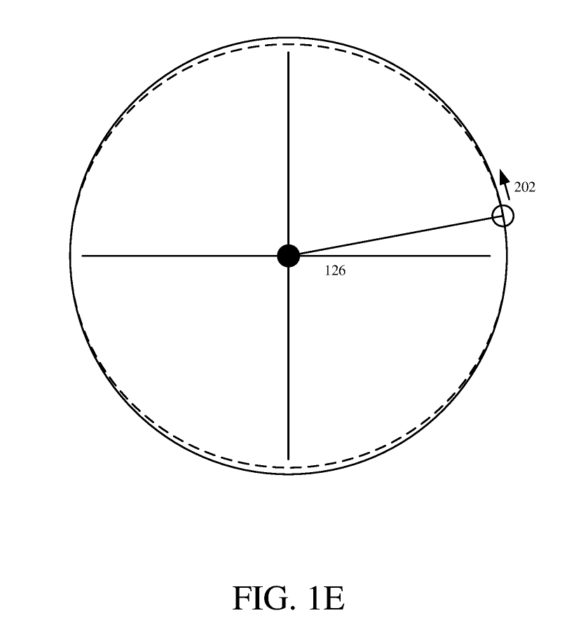

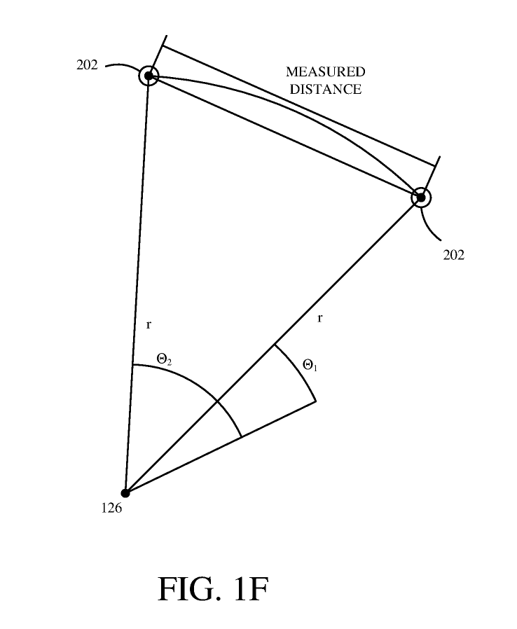

FIG. 1A illustratively shows a simplified block diagram of a three-dimensional non-contact scanning system 100 with which embodiments of the present invention are particularly useful. System 100 illustratively includes a pair of scanners 102(a) and 102(b), a controller 116, and a data processor 118. While much of the description will proceed with respect to a pair of scanners 102(a), 102(b), it is expressly contemplated that embodiments of the present invention can be practiced with a single scanner or more than two scanners. Additionally, embodiments of the present invention can be practiced where the scanner(s) use any suitable non-contact sensing technology including, without limitation, phase profilometry, stereovision, time-of-flight range sensing or any other suitable technology. For purposes of discussion only, reference numeral 102 will be used to generally refer to a scanner that includes features of either and/or both scanners 102(a) and 102(b).

FIG. 1 illustratively shows that object 112 is supported on rotary stage 110. Rotary stage 110 is an example of a motion control system that is able to generate relative motion between object 112 and scanners 102(a), 102(b). In some embodiments, the motion control system may be a Cartesian system using an X-Y table. Additionally, some embodiments may employ a motion control system on the scanner(s) in addition to or instead of a motion control system coupled to the stage 110. In some embodiments, rotary stage 110 may be transparent to the electromagnetic radiation used by one or both of scanners 102(a), 102(b). For example, in embodiments where scanners employ light in the visible spectrum, rotary stage 110 may be made of glass or some other suitably transparent material. In operation, rotary stage 110 is configured to move to a variety of positions about an axis of rotation, the axis of rotation being generally indicated at arrow 126. System 100 further illustratively includes a position encoder 114 that measures a precise angular position of rotary stage 110 about axis of rotation 126. Rotation of rotary stage 110 allows for object 112 to be moved, within scanning system 100, to a variety of precisely known positions, where those positions are determined based on the precise angular position of the rotary stage 110. Further, rotary stage 110 is configured to provide accurate rotation such that there is low wobble (e.g. minimal deviation from the axis of rotation 126 ) of the stage. Thus, system 100 is configured to scan the object from a plurality of precisely known positions of rotary stage 110. This provides three-dimensional surface data 120 for the entire surface area of the object, from various angles of imaging.

Embodiments of the present invention generally perform a coordinate transform to reduce errors caused by mechanical drift and other measurement inaccuracies. In features of the present invention where multiple scanners are used (e.g. scanners 102(a) and 102(b)) a coordinate transform maps each of the scanner coordinate systems to a world coordinate system. More specifically, but not by limitation, a calibration artifact is used to measure the effects of sensor opto-mechanical drift. Differences between each scanner's reported measurements and known information about the calibration artifact can be used to generate a coordinate transformation for each scanner that reduced the differences. As shown in FIG. 1, data processor 118 includes field transform logic 122. In one embodiment, field transform logic 122 includes instructions that are executable by data processor 118 to configure system 100 to generate a coordinate transform 124 for each scanner. As used herein, the term rigid body transform includes an adjustment in x, y, z, and rotation. Additionally, an “affine transform” is a transform that preserves straight lines and keeps parallel lines parallel. Additionally, a “projective transform” maps lines to lines, but does not necessarily maintain parallelism. It is noted that transforms such as rigid body and affine transforms are beneficial in systems where mechanical drifts and their associated corrections are relatively small. Here, in one embodiment, but not by limitation, multiple scanners and large mechanical drifts necessitate the use of a projective transform. Field transform logic 122 is generally executed during operation of system 100 to correct for mechanical drifts that have occurred since manufacture and initial characterization of the three-dimensional, non-contact scanning system.

Particular embodiments provided herein calibrate scanning system 100 by use of field transform logic 122, which generally maps data from each scanner coordinate system to a coordinate system that is tied to rotary stage 110. Specifically, measurements of a calibration artifact, placed on the rotary stage, are compared to accurately known geometry of said artifact. One particular system that uses field transform logic 122 also uses one or more ball bars to calibrate axis orthogonality of rotary stage 110 and to generate correction results. For instance, a measuring volume can be defined and one or more ball bars (with accurately known geometry) can be positioned in the defined volumetric space. Where the scanning system does not experience scale errors or drifts and when the system axis are orthogonal, the ball bar lengths are reported correctly.

FIG. 1B illustrates one embodiment of rotary stage 110 configured for use with ball bars, which are generally shown at reference numeral 130. Ball bars consist of two balls 202 and a rigid spacer 203. One example of the use of ball bars in a coordinate measuring system is found in ASME standard B89.4.10360.2. As shown in FIG. 1B, ball bars 130 are moved to three (or more) different positions to image the bars at three (or more) different angular positions of rotary stage 110. More specifically, but not by limitation, ball bars 130 are measured at various positions in the measurement volume while stage 110 is rotated to different angular positions. Measurement volume of scanners 102 is illustratively shown as cylinder, as indicated by reference numeral 136.

Ball bar 130(a) is illustratively shown as being positioned radially near the top edge of measurement volume 136. Further, ball bar 130(b) is positioned radially near the bottom edge of measurement volume 136. In addition, ball bar 130(c) is shown as being positioned vertically near a vertical edge of the cylinder that defines measurement volume 136. During field calibration, the user may use a single ball bar 130 placed sequentially at the several positions (a, b, c) or may use three ball bars 130(a, b, c) simultaneously. Note that the ball bars do not need to be precisely positioned relative to rotary stage 110. Accordingly, a user may place the calibration artifact in the sensing volume at an arbitrary position and the system will sweep the calibration artifact through most, if not all, of the sensing volume for the various scans. This means that the calibration artifact need not be placed in a pre-determined position or orientation on the stage for effective calibration.

In operation of system 100, in one embodiment, a first scan is performed and first measurement data 120 is generated for each of the ball bars 130 and their corresponding angular positions on rotary stage 110. By measuring the ball bars 130 at several different stage 110 positions, it is possible to collect data from much of the measurement volume 136. If the scanner(s) 102 have been perturbed from their original factory calibrated state (e.g. errors in scale or axes orthogonality) then several anomalies may be found in the measurement data 120; for instance the ball bar 130 lengths may be incorrect or seem to vary as the stage 110 rotates, the individual balls may seem to orbit rotary axis 126 in an ellipse, the balls may seem to orbit an axis which is displaced from the rotary stage axis, or the balls may seem to wobble in their orbit around axis 126. By noting these errors, data processor 118 may calculate a spatial mapping (such as a projective transform) from scanner 102 measurement space to a corrected world coordinate system.

Ball bars, as used in accordance with features described herein, are advantageous in that they are robust and inexpensive. For instance, any number of ball bars with any known measurements and in any orientation with respect to rotary stage 110 can be used. However, the use of ball bars may require repositioning of said bars to properly capture complete measurement data.

FIG. 1C illustratively shows a misestimated axis of rotation 127 which is offset from the true axis of rotation 126. As ball 202 orbits around axis 126, it will follow a nearly perfect circle (because the rotary stage has low wobble). If, due to a system calibration error, the estimated position of the axis of rotation 127 is offset from the true axis 126, then the estimated radius of rotation will vary as the stage rotates. This varying radius of rotation will be included when calculating the best field calibration correction.

FIG. 1D illustratively shows a misestimated axis of rotation 127 which is tilted from the true axis of rotation 126. The orbit of ball 202 around axis 126 forms a plane which is perpendicular to 126. If, due to a system calibration error, the estimated angle of the axis of rotation 127 is offset from the true axis 126, then the plane of rotation will appear to be tilted with respect to estimated axis 127. The position of ball 202 along the axis will appear to vary as the stage rotates. This varying position 129 along the axis of rotation will be included when calculating the best field calibration correction.

FIG. 1E illustratively shows an error in calibration causing either/or a scale difference between axes or an orthogonality error between axes. These errors will cause a ball 202 rotating around axis 126 to appear to follow an elliptical orbit rather than a circular orbit.

FIG. 1F illustratively shows the calculation of chord length, the distance a ball 202 moves due to a change in rotary stage angle, moving from stage position θ₁ to stage position θ₂. The measured distance the ball moved between the two stage angles is simply the Euclidean distance between the measured ball center positions. The true distance the ball moved may be calculated from the radius of rotation and the difference in stage angle: 12 r sin(θ₁−θ₂/2|. Errors in estimating the axis of rotation 126 or in axis scaling or orthogonality will cause a mismatch between the measured and true values. The difference between true and measured distance will be included when calculating the best field calibration correction.

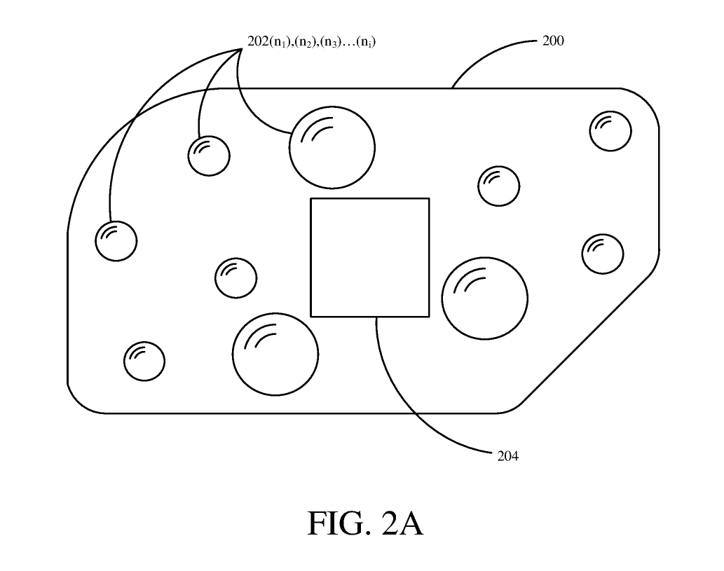

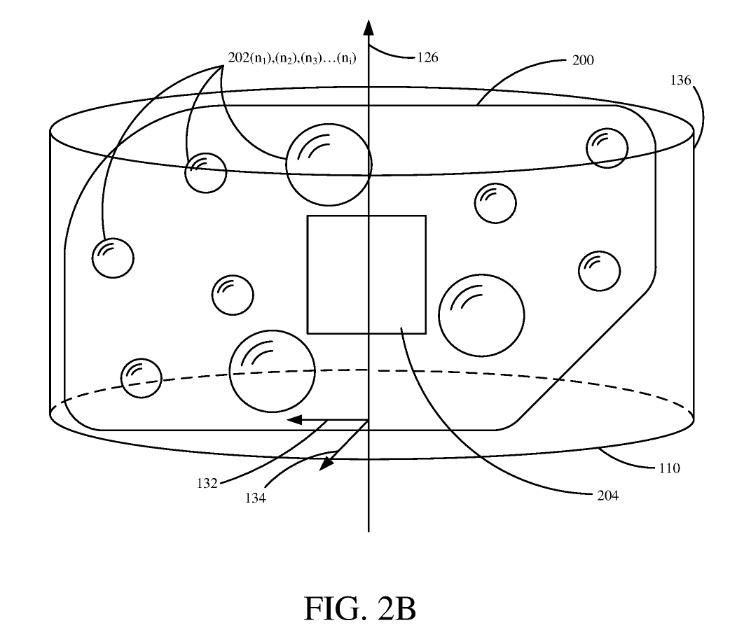

FIG. 2A illustratively shows a calibration artifact in the form of ball plate 200 configured for use in calibrating system 100, in accordance with one embodiment of the present invention. As noted above, ball bars are limited in their use with scanning systems. Ball plate 200 addresses the limitations of such ball bars.

Ball plate 200 illustratively includes any number of spheres 202(n₁),(n₂),(n₃) . . . (nᵢ). In the illustrated example, ball plate 200 includes 10 spheres 202 that project from both sides of plate 200. Spheres 202 are visible from all angles when viewing plate 200 with, for instance, sensing assemblies 102(a) and 102(b). In one embodiment, the centers of the spheres are substantially coplanar. However, embodiments of the present invention can be practiced where the calibration artifact is not a plate, but in fact a constellation of balls that do not have coplanar centers. Each sphere 202 of plate 200 is precisely measured at the time of manufacture of plate 200. Therefore, the measured diameter and X,Y,Z center position of each sphere 202 can be used as known data in performing field calibration of system 100. The algorithm described below treats the ball plate as a set of ball bars, where any pair of balls acts as a separate ball bar. Effectively, the illustrated example of ball plate 200 provides 45 ball pairs (e.g. 45 measurements of distance between sphere centers, such by effectively providing 45 ball bars manufactured into plate 200). In one embodiment, ball plate 200 includes a first plurality of balls having a first diameter and a second plurality of balls having a second diameter that is larger than the first diameter in order to unambiguously determine ball plate orientation in the scan data.

As shown in FIG. 2B, ball plate 200 is placed on rotary stage 110. As discussed above, system 100 uses a scanner to scan the object on stage 110 (in this case ball plate 200) from a number of rotational positions to calculate measurements corresponding to the distances between spheres 202. In this way, ball plate 200 effectively sweeps the entire measurement volume of scanner(s) 102. Note, even if ball plate 200 deforms slightly, the distance between the balls is relatively stable. To scan the ball plate 200, a first scan may occur at a first angular position, about axis of rotation 126, where that angular position is precisely measured by position encoder 114 (shown in FIG. 1). Unlike some uses of ball bars, ball plate 200 is configured to be placed in system 100 for imaging and data collection without any further manual intervention. Further, while some ball bars are limited in their ability to be measured (e.g. where three ball bars are used, the only collectable data for calibration is measurement data for those three positions), ball plate 200 provides dense surface properties and thus a fine granularity of calibration measurements.

It is also noted that the present disclosure provides improved features for obtaining known, accurate measurements of a calibration artifact. In an embodiment where a calibration artifact is a ball plate 200, ball plate 200 can include machine-readable visual indicia 204, as shown in FIGS. 2A and 2B. Machine readable visual indicia 204 can be any of a variety of visual indicia sensed by system 100 to provide the system with known, accurate positions of spheres 202. In one embodiment, but not by limitation, visual indicia 204 includes a matrix barcode such as a Quick Response Code (QR Code®). Upon imaging and processing visual indicia 204, system 100 can be configured to obtain information that describes the particular ball plate and sphere locations. This may be directly encoded in the QR Code® or available via a query to a database for data and/or metadata that matches indicia 204. For instance, system 100 obtains, from a database that is local, remote, or distributed from system 100, calibration artifact measurements that correspond to the particular artifact that is identified by sensing visual indicia 204. In another embodiment, ball bars 130 include visual indicia similar to that discussed with respect to ball plate 200 and visual indicia 204. More specifically, but not by limitation, scanners 102(a) or 102(b) detect visual indicia 204 and provide output to controller 116, which further provides said sensed output to data processor 118. Data processor 118 includes instructions that configure the system to query a database to identify measurements corresponding to sensed visual indicia 204, and thus to identify the accurate measurements of ball plate 200.

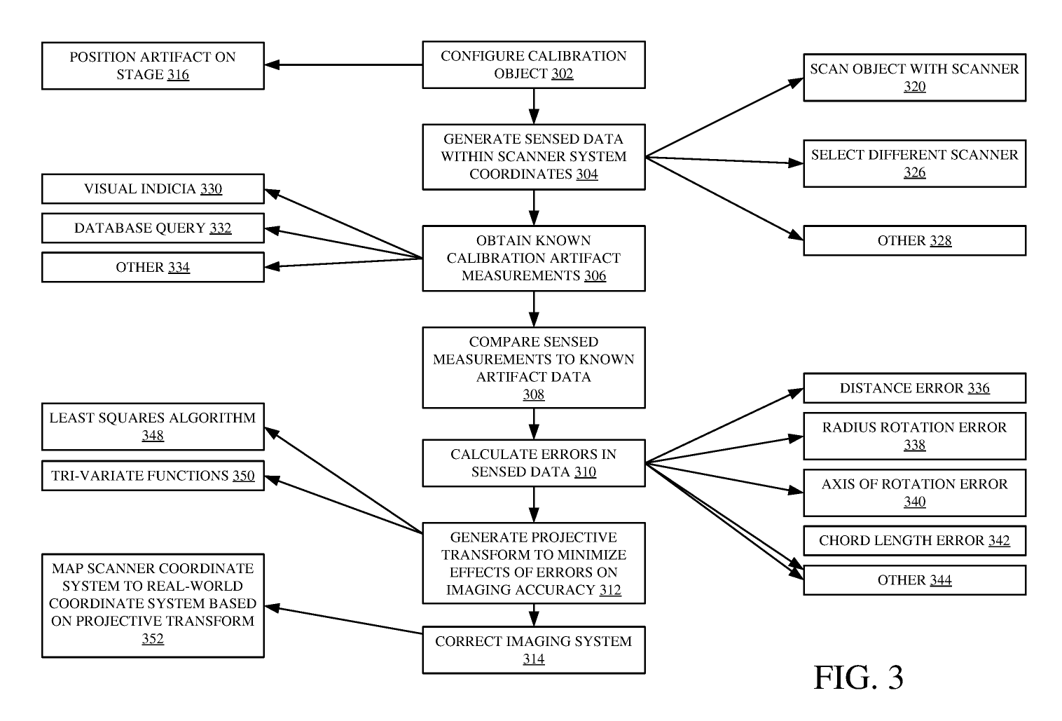

As discussed above, a variety of transforms can be performed by system 100 to map from uncorrected to corrected space. These transforms and their associated operations of system 100 will be further discussed below with respect to FIG. 3.

FIG. 3 shows a block diagram illustrating a method of calibrating a three-dimensional non-contact scanning system, in accordance with embodiments of the present invention. At block 302, the method illustratively includes configuring a calibration artifact for imaging in a scanning system. Configuring a calibration artifact (e.g. ball plate 200 and/or ball bars 103) in a scanning system can include positioning the artifact(s) on a stage, as indicated by block 316.

At block 304, the method illustratively includes collecting raw data that corresponds to scanner coordinates. Collecting raw data generally refers to the sensing of surface properties of an object that is imaged or otherwise detected by one or more cameras in a scanner. As noted above, each scanner has its own coordinate system, and therefore raw measurement data is dependent on that coordinate system. As indicated by block 320, collecting raw data includes scanning the calibration artifact with a scanner such as scanner 102(a) and/or 102(b). For instance, system 100 senses the calibration object relative to the particular scanner's coordinate system. Collecting raw data further illustratively includes collecting data from multiple stage positions. For instance, a rotary stage is rotated to a variety of angular positions. Rotation of the rotary stage allows for all surface features of the object to be viewable. In addition, the precise position of the rotary stage is determined with a position encoder that is coupled to the stage. As shown in FIG. 3, collecting raw data can include collecting data that corresponds to multiple different positions of the calibration artifact being imaged. The calibration artifact, such as a ball bar, can be moved to a variety of positions within the defined measurement area, thereby providing more dense data collection. Collecting raw data can further include collecting raw measurement data from multiple scanners at different viewing angles by selecting a different scanner, as indicated at block 326. For instance, one scanner may be configured to view light reflected from a top portion of a calibration artifact while another scanner may be configured to view light reflected from a bottom portion of the object. An example of an apparatus that has an upper and lower scanner is provided in U.S. Pat. No. 8,526,012. Other steps 328 can also or alternatively be used to facilitate collecting raw data within scanner system coordinates. For instance, other data 328 that is collected includes any of: sphere measurements, a sequence number, time, temperature, date, etc.

At block 306, the method illustratively includes obtaining known artifact measurement data. It is first noted that known artifact measurement data can include any measurement data for the artifact that is precisely known to be accurate (e.g. measured with accurate instrumentation at the time of manufacture of the artifact). In one example of block 330, a QR Code® is sensed by the scanning system. Based on the sensed QR Code®, the current artifact being imaged is identified. While a QR Code® is one type of visual indicia that can be provided on a surface of the calibration artifact for sensing, a variety of other visual indicia can also or alternatively be used. A matrix code (such as a QR Code®) may contain both the artifact identifying information and the actual artifact measurement data (the ball X, Y, Z positions and diameters). Further, other types of identifiers can also be used in accordance with embodiments of the present invention, such as RFID tags. Block 330 may further include querying a database for the known artifact measurement data corresponding to the identified calibration artifact, as illustratively shown at block 332. At block 334, other mechanisms for obtaining known artifact measurement data can be used in addition or alternatively to those discussed above. For instance, an operator can manually input known measurement data for the artifact being imaged. In a particular embodiment, three-dimensional, non-contact scanning system automatically identifies the artifact based on a sensed visual indicia (e.g. QR Code®) and further automatically retrieves relevant data.

Continuing with block 308, the method includes comparing the collected raw rata (e.g. raw data that is sensed using the scanner coordinate system) to the obtained known calibration artifact measurement data. Of course, a variety of comparisons can be done across the two data sets. In one embodiment, degrees of freedom of the scanning system are identified and used to calculate errors between the collected raw data and the known artifact data, in accordance with block 310. Further, for instance, one or more point clouds can be generated. A point cloud, as used herein, generally includes a collection of measurement properties of a surface of an imaged object. These surface measurements are converted to a three-dimensional space to produce a point cloud. It is noted that point clouds that are generated are relative to their respective sensing system. For instance, scanner coordinate systems (e.g. coordinates in three-dimensional space within the scanner's field of view) can vary, especially as a system ages and experiences mechanical drift. As such, calculated deviations between measured surface positions and expected surfaces positions can provide the system with an indication that a particular coordinate system (of one of the scanners) has drifted over time and requires re-calibration in the field.

Calculating errors, as shown at block 310, generally includes calculating variations between scanner data tied to a scanner coordinate system and known measurement data for a calibration artifact being imaged within the scanner coordinate system. Several examples of error calculations that can be performed in accordance with block 310 will now be discussed. At block 336, a distance error is calculated. A distance error generally includes a calculated difference between the collected raw measurement distance (e.g. sensed distance between two sphere 202 centers in ball plate 200) and the obtained accurate measurement distance. Calculating errors also illustratively includes calculating a rotation radius error, as shown at block 338. For instance, spheres or balls of a calibration artifact will rotate within the scanning system at a constant radius (e.g. on a stage with minimal wobble). As such, when calibration errors occur due to mechanical drift, for instance, block 338 includes calculating a variation in radius for each artifact (e.g. sphere or ball) at each angle of rotation around the rotary stage. In addition, the method includes identifying variations in the direction along the axis of rotation of the artifact object. In accordance with block 340, calculating errors illustratively includes calculating errors or variations in the position, along the axis of rotation (e.g. Y axis of rotation 126) of the calibration artifact as it rotates on the stage. As a calibration artifact is rotated about the axis of rotation, the calibration artifact passes around an orbit of the rotation, defined in part by the measurement volume. The method illustratively includes calculating errors in chord length of calibration artifact features as they rotate around the orbit, as indicated at block 342. For instance, the total orbit distance that is traveled by the calibration artifact should match the measured chord distance of the balls as they rotate where there is no mechanical drift or other measurement inaccuracies. As an example only, and not by limitation, measured chord length can be compared to known measurements to calculate errors by using the following equation:

$$Error = measuredChord - \vert 2 r sin ( \frac{{θ}_{1} - {θ}_{2}}{2} ) \vert \qquad Equation 1$$

Of course, a variety of additional or alternative error calculations can be used. Other error calculations are shown at block 344.

Continuing with block 312, the method illustratively includes generating a spatial mapping such as a projective transform to minimize a sum of the calculated errors. A variety of techniques can be used to generate a coordinate transform, in accordance with embodiments of the present invention. In one embodiment, block 312 includes determining an appropriate algorithm to use in generating the coordinate transform. For instance, where the method determines, at block 310, that the calculated errors are relatively small, a coordinate transform can be employed to convert points in scanner coordinates to points in world coordinates using a rigid body or affine transform. Equation 2A is an example of an affine transform matrix array:

$${X}_{W} = [ \begin{matrix}{a}_{00} & {a}_{01} & {a}_{02} & {a}_{03} \\ {a}_{10} & {a}_{11} & {a}_{12} & {a}_{13} \\ {a}_{20} & {a}_{21} & {a}_{21} & {a}_{23}\end{matrix} ] {X}_{C} \qquad Equation 2 A$$

If errors are larger, a projective array as shown in Equation 2B can be used:

$${X}_{W} = [ \begin{matrix}{a}_{00} & {a}_{01} & {a}_{02} & {a}_{03} \\ {a}_{10} & {a}_{11} & {a}_{12} & {a}_{13} \\ {a}_{20} & {a}_{21} & {a}_{21} & {a}_{23} \\ {a}_{30} & {a}_{31} & {a}_{32} & 1\end{matrix} ] {X}_{C} \qquad Equation 2 B$$

As shown in Equation 2, X_{W} is a world position (i.e. position tied to a rotary stage) and X_{C} is the point position in scanner coordinate system [x,y,z,1]^{T}. Equations 2 map from X_{C} to X_{W}.

The values in the transform matrices may be calculated using a least squares algorithm, as illustrated at block 348. One example of a least squares algorithm that can be used in accordance with block 312 is the Levenberg-Marquardt algorithm. In this and similar algorithms, the sum of the squares of the deviations (e.g. errors) between the sensed measurement values and the obtained known calibration measurement values is minimized.

Further, in example systems where it is determined that mechanical drifts are large (e.g. error calculations are indicative of large deviations between scanner coordinate system measurement outputs and known measurements), generating a coordinate transform illustratively includes using tri-variate functions such as polynomials. A polynomial allows correction of non-linear errors that can occur if there is a large mechanical change in the sensing system. This is shown at block 350. As such, the projective transform is no longer a linear algebraic equation. Rather, in one example, a set of three polynomials having the following functions are used where the W subscript indicates world coordinates and the C subscript indicates scanner coordinates.

x_{W}=Fₓ(x_{c}, y_{c}, z_{C}) Equation 3

y_{W}=F_{y}(x_{c}, y_{c}, z_{C}) Equation 4

z_{W}=F_{z}(x_{c}, y_{c}, z_{C}) Equation 5

At block 314, the method illustratively includes the step of correcting the scanning system based on the coordinate transform that is generated. In one embodiment, block 314 includes using the projective transform to map the data obtained using the scanner coordinate system (where the coordinate system is determined to produce measurement inaccuracies, e.g. block 310 ) to a world coordinate system that is tied to the rotary stage. For instance, in addition to determining deviations (e.g. errors) between measurements sensed by the factory-calibrated scanner coordinate system and the measurements known to be accurate at the various precise positions of a stage, systems and methods in accordance with embodiments herein calibrate the scanner coordinate system in the field using the coordinate transform. As such, deviations can be used to correct mechanical drifts within each of the scanner coordinate systems, as each coordinate system varies individually. Mapping a scanner coordinate system to a world system, based on the transform, is indicated at block 352.

With the coordinate transforms determined for each scanner, the system can use the transforms to more accurately sense objects placed within the scanning volume. Accordingly, after the coordinate transforms are determined, they are used to scan objects placed in the sensing volume more accurately. The field calibration described above can be performed at any suitable interval such as after a certain number of objects have been scanned, at the end or beginning of a shift, etc.

While embodiments described thus far have focused on a single operation that obtains the requisite spatial mapping to correct the coordinate system for each scanner, embodiments of the present invention also include iteration of the method. For example, the general result of the process is to obtain a spatial mapping from scanner coordinates (uncorrected) to world coordinates (corrected). For example, the equation: X_{W}=PX_{C} provides a projective transform, P, that maps the scanner coordinates (X_{C}) to world coordinates (X_{W}).

The calculation of P is, in one embodiment, based on the measured center positions of a number of spheres. First, points on the surface of the spheres in the scanner coordinate system are measured, then the sphere centers are calculated (still in the scanner coordinate system). These sphere center positions are then provided to a least squares solver to minimize errors in order to obtain P. Generally, the method begins by finding the surface of a sphere in the scanner coordinates. Then, for each sphere, the center of the identified surface is calculated (in the scanner coordinate system). Then, the sphere centers are used to calculate P. In some instances, the scanner calibration or correction can be large enough that the surface of the spheres can be distorted enough that there is a small but meaningful error in finding the true sphere centers. The iterative technique remedies this problem.

The iterative technique proceeds as follows. First, (1) the surface of the spheres is found in the scanner coordinate system. Again, (2) for each sphere, the center is calculated (in the scanner coordinate system). Next, (3) the sphere centers are used to calculate P. On the first iteration, this step P is close to correct, but not exact. Next, (4) P is applied to the sphere surface found in the step 1 (the surface is now approximately correlated). Next, (5) the centers of the corrected sphere surfaces are found. Next, (6) the corrected center position of the spheres is moved back to the scanner coordinate system: X_{C}=P⁻¹X_{W}, where P⁻¹ is the inverse of the P transform. Next, steps 3-6 are repeated using the more accurately estimated sphere centers for a better estimate of P.

Although the present invention has been described with reference to preferred embodiments, workers skilled in the art will recognize that changes may be made in form and detail without departing from the spirit and scope of the invention.

What is claimed is:

1. A three-dimensional non-contact scanning system comprising:
a stage;
at least one scanner configured to scan an object on the stage;
a motion control system configured to generate relative motion between the at least one scanner and the stage;
a controller coupled to the at least one scanner and the motion control system, the controller being configured to perform a field calibration wherein:
an artifact having features with known positional relationships is scanned by the at least one scanner in a plurality of different orientations to generate sensed measurement data corresponding to the features;
deviations between the sensed measurement data and the known positional relationships are determined; and
based on the determined deviations, a coordinate transform is calculated for each of the at least one scanner where the coordinate transform reduces the determined deviations.

2. The three-dimensional non-contact scanning system of claim 1, wherein the stage is a rotary stage and the motion control system is configured to rotate to the rotary stage to a plurality of precise angular positons about an axis of rotation.

3. The three-dimensional non-contact scanning system of claim 2, and further comprising:
a position encoder operably coupled to the rotary stage and configured to sense the plurality of precise angular positions of the rotary stage.

4. The three-dimensional non-contact scanning system of claim 1, wherein the artifact is a constellation of spheres having non-coplanar centers.

5. The three-dimensional non-contact scanning system of claim 1, wherein the artifact is a ball plate.

6. The three-dimensional non-contact scanning system of claim 5, wherein the controller is further configured to:
receive an indication of a sensed visual indicia, corresponding to the ball plate.

7. The three-dimensional non-contact scanning system of claim 6, wherein the controller is further configured to:
based on the indication of the sensed visual indicia, identify the calibration artifact and query a database for the known positional relationships that correspond to features of the identified artifact.

8. The three-dimensional non-contact scanning system of claim 6, wherein the controller is further configured to identify the calibration artifact and the known positional relationships that correspond to features of the identified artifact encoded in the visual indicia.

9. The three-dimensional non-contact scanning system of claim 6, wherein the sensed visual indicia comprises a matrix code positioned on a surface of the artifact.

10. The three-dimensional non-contact scanning system of claim 9, wherein at least one scanner is configured to sense the matrix code and provide the indication of the sensed matrix code to the controller.

11. The three-dimensional non-contact scanning system of claim 5, wherein the ball plate includes a plurality of balls fixed relative to one another and mounted to a plate such that each ball extends from opposite surfaces of the plate.

12. The three-dimensional non-contact scanning system of claim 11, wherein the ball plate includes a first plurality of balls having a first diameter and a second plurality of balls having a second diameter that is larger than the first diameter.

13. The three-dimensional non-contact scanning system of claim 11, wherein the ball plate is configured to stand with a plane of the plate oriented vertically.

14. The three-dimensional non-contact scanning system of claim 1, wherein the at least one scanner includes a first scanner configured to scan the object from a first elevation angle and a second scanner configured to scan the object from a second elevation angle that is different from the first elevation angle.

15. The three-dimensional scanning system of claim 14, wherein the controller is configured to:
generate a first plurality of scans that includes sensed measurement data in the first scanner coordinate system;
generate a second plurality of scans that includes sensed measurement data in the second scanner coordinate system; and
generate a first transform that maps the first scanner coordinate system to stage space and a second transform that maps the second scanner coordinate system to stage space.

16. The three-dimensional non-contact scanning system of claim 1, wherein the controller is configured to scan a subsequent object using the coordinate transform relative to each of the at least one scanner to provide a calibrated scan of the subsequent object.

17. A method of calibrating a three-dimensional non-contact scanning system, the method comprising:
placing and artifact having a plurality of features with known positional relationships in a sensing volume of the scanning system;
scanning the artifact with at least one scanner from a plurality of different orientations to obtain sensed measurement data that is referenced to a coordinate system of the respective scanner;
determining deviations between the sensed measurement data and the known positional relationships of the plurality of features;
based on the determined deviations, generating a respective coordinate transform for each scanner of the at least one scanner that reduces the determined deviations by mapping the respective scanner coordinate system to a world coordinate system.

18. The method of claim 17, wherein a type of coordinate transform is selected based on a magnitude of the determined deviations.

19. The method of claim 18, wherein the coordinate transform is a rigid body transform.

20. The method of claim 18, wherein the coordinate transform is a projective transform.

21. The method of claim 18, wherein the coordinate transform is an affine transform.

22. The method of claim 18, wherein the coordinate transform is a polynomial transform.

23. The method of claim 18, wherein the deviations are deviations in chord length.

24. The method of claim 17, wherein the deviations are based on a misestimated axis of rotation.

25. The method of claim 17, wherein the deviations are based on an orthogonality error between axes.

26. The method of claim 17, wherein the deviations are lengths of ball bars.

27. The method of claim 17, wherein the deviations are ball diameters.

28. The method of claim 17, wherein the deviations are a sum of different types of deviations.

29. A three-dimensional non-contact scanning system comprising:
a stage configured to receive an object to scan;
a first scanner configured to scan an object from a first elevation angle;
a second scanner configured to scan the object from a second elevation angle different from the first elevation angle;
a motion control system disposed to generate relative motion between the stage and the first and second scanners;
a position detection system coupled to the motion control system and configured to provide an indication of a position of the stage relative to the first and second scanners;
a controller coupled to the first scanner, the second scanner, the motion control system, and
the position detection system, the controller being configured to:
cause at least one of the first and second scanners to scan a ball plate having a plurality of features with known positional relationships on the stage at each a set of different positions;
generate a series of measurements, wherein each measurement in the series of measurements corresponds to a particular position within the set of positions;
generate a first coordinate transform that maps a coordinate system of the first scanner to a coordinate system of the stage and a second transform that maps a coordinate system of the second scanner to the coordinate system of the stage.
